(19) United States
(12) Patent Application Publication
(10) Pub. No.: US 2022/0052340 A1
(43) Pub. Date: Feb. 17, 2022

(54) PREPARATION AND APPLICATION OF COPPER FLUORIDE/FLUORINATED GRAPHENE COMPOSITE MATERIAL WITH HIGH ENERGY DENSITY

(71) Applicant: TIANJIN UNIVERSITY, Tianjin (CN)

(72) Inventors: Wei FENG, Tianjin (CN); Lidong SUN, Tianjin (CN); Yu LI, Tianjin (CN); Cong PENG, Tianjin (CN)

(21) Appl. No.: 17/398,211

(22) Filed: Aug. 10, 2021

(30) Foreign Application Priority Data
Aug. 15, 2020 (CN) 202010822110.1

(51) Int. Cl. H01M 4/58; H01M 10/052; H01M 4/62; H01M 4/36; H01M 4/04

(52) U.S. Cl. CPC H01M 4/58; H01M 10/052; H01M 2004/021; H01M 4/364; H01M 4/0471; H01M 4/623

(57) ABSTRACT

The present application relates to a method for preparing a copper fluoride/fluorinated graphene composite material with high-energy density, comprising mixing copper fluoride and fluorinated graphene in a ratio of (0.8 to 9):1, ball milling the mixed copper fluoride and fluorinated graphene in a sealed ball milling tank, after ball milling, putting the sealed ball milling tank into a glove box, and taking out a sample. The prepared copper fluoride/fluorinated graphene composite material is applied to a lithium metal battery cathode material.

### CROSS REFERENCE TO RELATED APPLICATIONS

This application claims the priority of Chinese Patent Application No. CN202010822110.1, filed on Aug. 15, 2020 and titled with “PREPARATION AND APPLICATION OF COPPER FLUORIDE/FLUORINATED GRAPHENE COMPOSITE MATERIAL WITH HIGH ENERGY DENSITY”, and the disclosure of which is hereby incorporated by reference.

### FIELD

The present application relates to the technical field of metal fluoride materials, and in particular to a method for preparing copper fluoride/fluorinated graphene composite material by ball milling copper fluoride and fluorinated graphene using a sealed ball mill.

### BACKGROUND

A lithium primary battery has become a main power source for a long-term and high-capacity energy product. Copper fluoride has a high discharge capacity of 528 mAh/g, high discharge plateau of 3.55V, and high energy density (1874 Wh/kg), which is a promising electrode material. A fluorinated carbon material (CFₓ, x=1) has a theoretical capacity of 865 mAh/g, and an open circuit voltage of thermodynamic theory of 4.57V. However, the actual discharge plateau of the fluorinated carbon material is much lower than the theoretical value. In order to obtain a lighter mass, smaller volume, high-energy storage power supply device, the fluorinated carbon material with low density needs to be combined with the fluorinated metal material to obtain a lithium metal battery cathode material with a higher energy density, and smaller volume and mass.

In order to improve the energy density of the lithium primary battery, a copper fluoride/fluorinated graphene composite material for a lithium metal battery cathode material is prepared according to the present application, so as to achieve the purpose of preparing a cathode material with high-density and high-energy.

### SUMMARY

The purpose of the present application is to overcome the shortcomings of the prior art. In order to solve the problems of low compaction density of the fluorinated carbon and low discharge plateau in the prior art, the present application provides a method for preparing a copper fluoride/fluorinated graphene composite material for a lithium metal battery cathode material, in which the copper fluoride can increase the overall density of the composite material and improve the discharge plateau.

The technical purpose of the present application is achieved through the following technical solutions:

A method for preparing a copper fluoride/fluorinated graphene composite material with high-energy density is provided, comprising mixing copper fluoride and fluorinated graphene in a ratio of (0.8 to 9):1; ball milling the mixed copper fluoride and fluorinated graphene in a sealed ball milling tank; after ball milling, putting the sealed ball milling tank into a glove box; and taking out a sample.

In an embodiment of the present application, the copper fluoride and the fluorinated graphene are mixed in a mass ratio of (0.4 to 4):1.

In an embodiment of the present application, the copper fluoride and the fluorinated graphene are mixed in a mass ratio of (0.8 to 4):1.

In an embodiment of the present application, the copper fluoride and the fluorinated graphene are mixed in a mass ratio of (0.8 to 1):1.

In an embodiment of the present application, the copper fluoride and the fluorinated graphene are mixed in a mass ratio of (1 to 4):1.

In an embodiment of the present application, the copper fluoride and the fluorinated graphene are mixed in a mass ratio of 3:7 to 1:1.

In an embodiment of the present application, the copper fluoride and the fluorinated graphene are mixed in a mass ratio of (4 to 9):1.

In an embodiment of the present application, the copper fluoride and the fluorinated graphene are mixed in a mass ratio of 4:1.

In an embodiment of the present application, the copper fluoride and the fluorinated graphene are mixed in a mass ratio of 3:7.

Preferably, the copper fluoride and the fluorinated graphene are mixed in a mass ratio of 1:1.

The ball milling is performed on a planetary ball mill with a rotation speed of 300 revolutions per minute and a time of 2 hours.

Use of the copper fluoride/fluorinated graphene composite material in a lithium metal battery cathode material is provided.

The technical solutions of the present application are convenient and easy to implement. Moreover, the electrode material can be controlled by the mass ratio of copper fluoride and fluorinated graphene to improve the overall electrochemical performance of the composite material. The scanning electron micrographs of copper fluoride and copper fluoride/fluorinated graphene (5:5) are shown in FIGS. 1 to 4, indicating that the combination of copper fluoride and fluorinated graphene is very good. The XRD characterization shows that the copper fluoride and fluorinated graphene composite material was successfully prepared.

### BRIEF DESCRIPTION OF THE DRAWINGS

FIG. 1 is a scanning electron microscope of copper fluoride according to the present application;

FIG. 2 is a scanning electron micrograph of copper fluoride according to the present application;

FIG. 3 is a scanning electron micrograph of fluorinated graphene according to the present application;

FIG. 4 is a scanning electron micrograph of copper fluoride/fluorinated graphene according to the present application;

FIG. 5 is a scanning electron micrograph of copper fluoride/fluorinated graphene according to the present application;

FIG. 6 is an XRD of copper fluoride/fluorinated graphene prepared according to the present application;

FIG. 7 is a constant current discharge curve diagram of the fluorinated graphene according to the present application;

FIG. 8 is a constant current discharge curve diagram of the copper fluoride/fluorinated graphene composite material with different ratios prepared according to the present application.

### DETAILED DESCRIPTION

The technical solution of the present application will be further described below in conjunction with specific embodiments. The purity of copper fluoride purchased from Shanghai Aladdin is 99.5%.

### EXAMPLE 1

(1) In a glove box, 200 mg of copper fluoride is transferred to a sealed ball mill tank and milled at 300 rpm for two hours.

(2) After the ball milling, the sealed ball mill tank is transferred to the glove box, and the sample is taken out.

(3) The sample 80 mg, carbon black 10 mg, and binder (PVDF) 10 mg are ground in the glove box, and the ground slurry are evenly coated on the aluminum foil with carbon and placed on a heating table for drying at 120° C. for 24 h. The positive electrode materials weighed and cut are 4.2 mg, 4.1 mg, and 4.0 mg, respectively.

### EXAMPLE 2

(1) In a glove box, 180 mg of copper fluoride and 20 mg of fluorinated graphene are transferred to a sealed ball mill tank and milled at 300 rpm for two hours.

(2) After the ball milling, the sealed ball mill tank is transferred to the glove box, and the sample is taken out.

(3) The sample 80 mg, carbon black 10 mg, and binder (PVDF) 10 mg are ground in the glove box, and the ground slurry are evenly coated on the aluminum foil with carbon and placed on a heating table for drying at 120° C. for 24 h. The positive electrode materials weighed and cut are 4.5 mg, 4.1 mg, and 4.3 mg, respectively.

### EXAMPLE 3

(1) In a glove box, 160 mg of copper fluoride and 40 mg of fluorinated graphene are transferred to a sealed ball mill tank and milled at 300 rpm for two hours.

(2) After the ball milling, the sealed ball mill tank is transferred to the glove box, and the sample is taken out.

(3) The sample 80 mg, carbon black 10 mg, and binder (PVDF) 10 mg are ground in the glove box, and the ground slurry are evenly coated on the aluminum foil with carbon and placed on a heating table for drying at 120° C. for 24 h. The positive electrode materials weighed and cut are 4.7 mg, 4.6 mg, and 4.1 mg, respectively.

### EXAMPLE 4

(1) In a glove box, 100 mg of copper fluoride and 100 mg of fluorinated graphene are transferred to a sealed ball mill tank and milled at 300 rpm for two hours.

(2) After the ball milling, the sealed ball mill tank is transferred to the glove box, and the sample is taken out.

(3) The sample 80 mg, carbon black 10 mg, and binder (PVDF) 10 mg are ground in the glove box, and the ground slurry are evenly coated on the aluminum foil with carbon and placed on a heating table for drying at 120° C. for 24 h. The positive electrode materials weighed and cut are 4.9 mg, 4.3 mg, and 4.1 mg, respectively.

### EXAMPLE 5

(1) In a glove box, 60 mg of copper fluoride and 140 mg of fluorinated graphene are transferred to a sealed ball mill tank and milled at 300 rpm for two hours.

(2) After the ball milling, the sealed ball mill tank is transferred to the glove box, and the sample is taken out.

(3) The sample 80 mg, carbon black 10 mg, and binder (PVDF) 10 mg are ground in the glove box, and the ground slurry are evenly coated on the aluminum foil with carbon and placed on a heating table for drying at 120° C. for 24 h. The positive electrode materials weighed and cut are 4.3 mg, 4.6 mg, and 4.2 mg, respectively.

### EXAMPLE 6

(1) In a glove box, 200 mg of fluorinated graphene is transferred to a sealed ball mill tank and milled at 300 rpm for two hours.

(2) After the ball milling, the sealed ball mill tank is transferred to the glove box, and the sample is taken out.

(3) The sample 80 mg, carbon black 10 mg, and binder (PVDF) 10 mg are ground in the glove box, and the ground slurry are evenly coated on the aluminum foil with carbon and placed on a heating table for drying at 120° C. for 24 h. The positive electrode materials weighed and cut are 4.2 mg, 4.3 mg, and 4.4 mg, respectively.

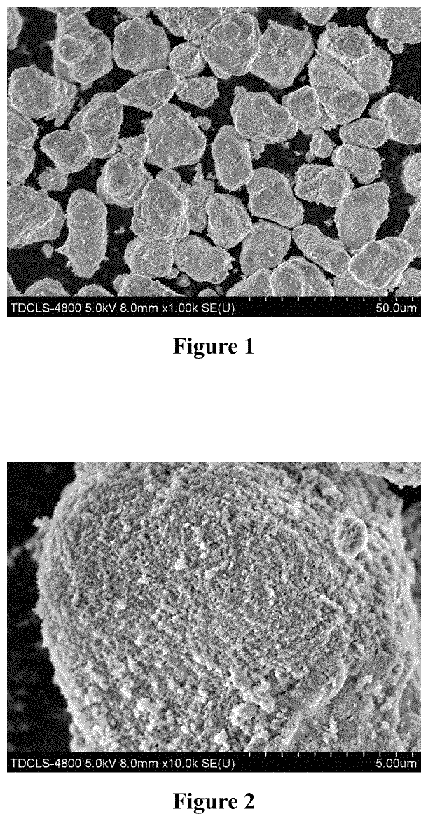

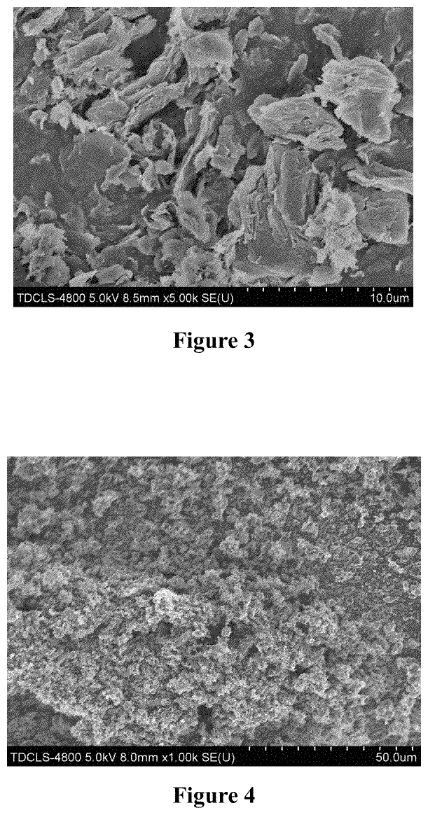

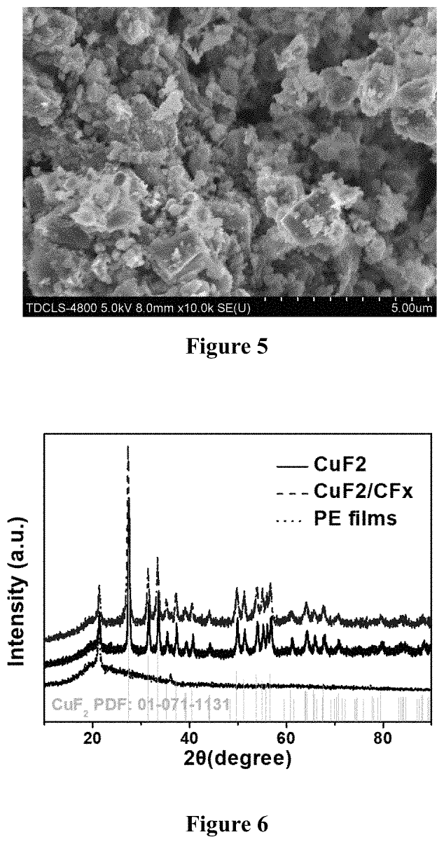

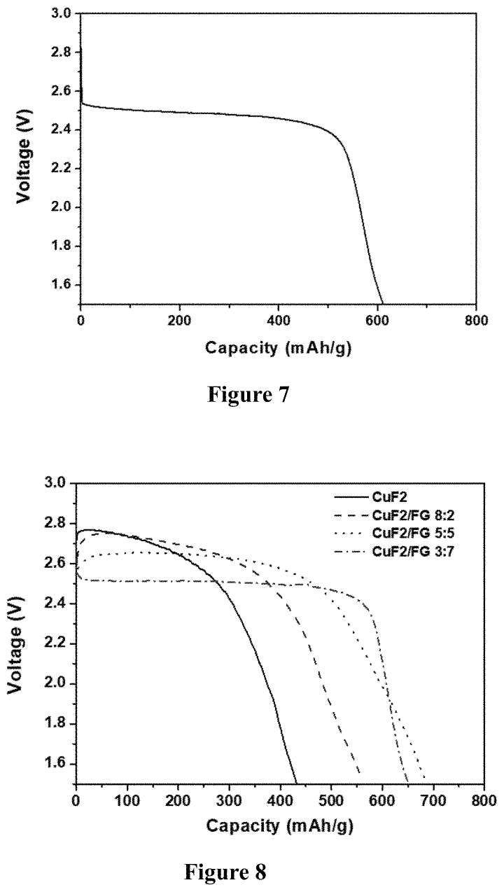

The battery is connected to the LAND battery test system, and after standing for 10 minutes, a constant current discharge performance test is performed. The test discharge current is 100 mAg⁻¹, and the discharge termination voltage is 1.5V. The test uses a button battery to directly measure the data. For example, FIGS. 1 and 2 are commercially available copper fluoride particles, and FIG. 3 is fluorinated carbon, and FIGS. 4 and 5 are composite materials of copper fluoride and fluorinated graphene. As shown in FIG. 6, it can be proved that the copper fluoride and fluorinated graphene composite material is successfully prepared. FIG. 7 shows a high discharge capacity and discharge plateau.

By adjusting the process parameters according to the content of the present application, the preparation of the copper fluoride/fluorinated graphene composite material can be achieved, and the performance of the copper fluoride and fluorinated graphene composite material is basically consistent with that of the present application after testing. That is, the copper fluoride and fluorinated graphene composite material is used as the lithium metal cathode material, the discharge medium voltage is 2.61V to 2.64V, and the specific capacity is 432.2 mAh/g to 687.5 mAh/g. The energy density of other ratios are 1068 Wh/kg for copper fluoride, 1391 Wh/kg for copper fluoride/fluorinated graphene (8:2), and 1582 Wh/kg for copper fluoride/fluorinated graphene (3:7), and the energy density of copper fluoride/fluorinated graphene (5:5) is the best to reach 1815 Wh/kg. Compared with fluorinated graphene (1494 Wh/kg), the composite material not only improves the discharge plateau but also increases the discharge capacity. The present application has been exemplarily described above. It should be noted that, without departing from the core of the present application, any simple deformation, modification, or other equivalent substitutions that can be made by those skilled in the art without creative work fall into the protection scope of the present application.

1. A method for preparing a copper fluoride/fluorinated graphene composite material with high-energy density, comprising:
mixing copper fluoride and fluorinated graphene in a ratio of (0.8 to 9):1;
ball milling the mixed copper fluoride and fluorinated graphene in a sealed ball milling tank;
after ball milling, putting the sealed ball milling tank into a glove box; and taking out a sample.

2. The method according to claim 1, wherein the copper fluoride and the fluorinated graphene are mixed in a mass ratio of (0.8 to 4):1.

3. The method according to claim 1, wherein the copper fluoride and the fluorinated graphene are mixed in a mass ratio of (0.8 to 1):1.

4. The method according to claim 1, wherein the copper fluoride and the fluorinated graphene are mixed in a mass ratio of (1 to 4):1.

5. The method according to claim 1, wherein the copper fluoride and the fluorinated graphene are mixed in a mass ratio of 1:1.

6. The method according to claim 1, wherein the ball milling is performed on a planetary ball mill with a rotation speed of 300 revolutions per minute and a time of 2 hours.

7. A method for preparing a lithium metal battery cathode material, comprising using the copper fluoride/fluorinated graphene composite material prepared according to claim 1.
